(19) United States
(12) Patent Application Publication
(10) Pub. No.: US 2004/0010442 A1
(43) Pub. Date: Jan. 15, 2004

(54) Descriptive characteristics for sales forecasts and sales orders

(76) Inventors: Stefan Merker, Mannheim (DE); Christian Farhad Woehler, Heidelberg (DE); Thomas Kretz, Ostringen (DE); Thomas John, Weinheim (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/306,815

(22) Filed: Nov. 27, 2002

Related U.S. Application Data
(60) Provisional application No. 60/395,245, filed on Jul. 10, 2002.

(51) Int. Cl. G06F 17/60

(52) U.S. Cl. 705/10

(57) ABSTRACT

A method that is performed on a computer is used in managing a supply chain. The method includes storing a sales forecast in association with data defining projected sales in terms of product, location, and at least one other descriptive characteristic. The method also includes receiving a sales order and processing the sales forecast and the sales order.

### CROSS-REFERENCE TO RELATED APPLICATION

This application claims priority to U.S. Provisional Application No. 60/395,245, filed on Jul. 10, 2002, the contents of which are hereby incorporated by reference into this application as if set forth herein in full.

### TECHNICAL FIELD

This application relates generally to defining sales forecasts and sales orders using descriptive characteristics and to using those descriptive characteristics to provide additional flexibility in supply chain planning and management.

### BACKGROUND

A sales order defines an actual sale. By contrast, a sales forecast defines projected future sale(s). Sales forecasts are typically determined for a specified period using statistical methods and historical data.

Heretofore, sales forecasts were defined in terms of product and location. That is, a sales forecast specified the product to be sold and the location from which the sold product could be shipped. In a supply chain, the location could be, e.g., a manufacturing facility, a warehouse, or any other point of distribution in the supply chain.

Defining sales forecasts in these limited terms reduces flexibility in product planning and deliveries.

### SUMMARY

In general, in one aspect, the invention is directed to a method, performed on a computer, for use in managing a supply chain. The method includes storing a sales forecast in association with data defining a product, location, and at least one other descriptive characteristic. The method also includes receiving a sales order, and processing the sales forecast and the sales order. This aspect may include one or more of the following features.

The sales order may define a sale in terms of product, location, and at least one other descriptive characteristic. The method may also include comparing the product, location, and at least one other descriptive characteristic from the sales forecast to the product, location, and at least one other descriptive characteristic from the sales order. The method may include consuming at least a portion of the sales forecast if there is at least one match between the product, location, and at least one other descriptive characteristic from the sales forecast and the product, location, and at least one other descriptive characteristic from the sales order. Consuming means replacing requirements of the sales forecast with requirements of the sales order.

An additional descriptive characteristic may relate to customer identity. Thus, the sales forecast may be customer-specific. Processing the sales order and forecast may include comparing the customer identity associated with the sales order to a customer identity associated with the sales forecast. If the customer identity of the sales order corresponds to the customer identity of the sales forecast, the sales order may consume the sales forecast.

The method may include performing an available-to-promise check using the sales forecast based on the at least one other descriptive characteristic. The method may include prioritizing at least one of the sales order and the sales forecast by customer identity and/or making product substitutions for distribution based on customer identity. The method may include transferring supply connected to a sales order or forecast to a demand planning application using the at least one other descriptive characteristic.

In other aspects, the invention is directed to an apparatus and machine-readable medium that are used in performing the foregoing method.

Other features and advantages of the invention will become apparent from the following description, including the claims and drawings.

### DESCRIPTION OF THE DRAWINGS

FIG. 1 is a block diagram of a computer that contains software for processing sales forecasts and sales orders.

FIG. 2 is a flowchart showing a process that utilizes additional descriptive characteristics when handling forecasts and sales orders.

### DESCRIPTION

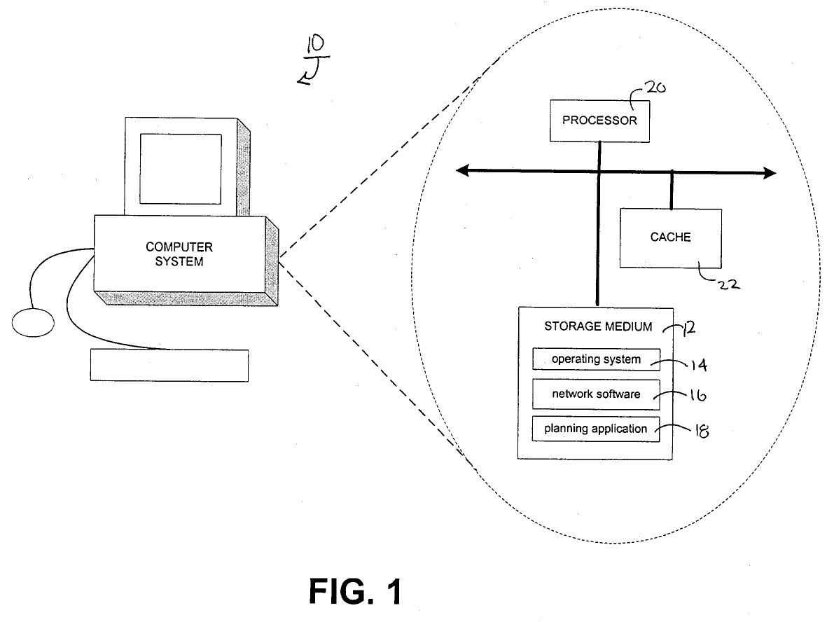

FIG. 1 shows a computer system 10. Computer system 10 contains a hard disk 12 that stores software, such as operating system software 14 and network software 16 for communicating over a network. Hard disk 12 also stores other software, including, but not limited to, planning application 18. In this embodiment, processor 20 executes planning application 18 to perform the functions described below.

Planning application 18 contains various software routines for use in supply chain management. Supply chain management refers, generally, to managing commerce (e.g., production planning and deliveries) between a manufacturer, various intermediaries, such as distribution centers and wholesalers, and customers. To this end, planning application 18 may include software routines for forecasting sales, allocating resources, processing and satisfying sales orders, and controlling distribution and allocation of goods to/from various points along the supply chain.

Planning application 18 makes use of sales forecasts in determining how to allocate and distribute goods. As noted above, a sales forecast defines projected future sales. The sales forecast thus may contain the number of goods to be sold and a timeframe during which the goods are to be sold. Sales forecasts may be determined within planning application 18 or entered into planning application 18 from an external source (e.g., from a demand planning application running on a remote computer system). The sales forecasts may be determined using historical data, such as prior sales, and statistical information, which may take into account product requirements from samples of customers or other users. The sales forecasts may be determined specifically for one or more of the descriptive characteristics noted below. For example, a sales forecast may be determined for a customer, purchasing organization, purchasing area, purchasing group, planner, etc. Sales orders may be entered into planning application 18 from an external source (e.g., a connected computer system or a sales application running on a remote computer system).

Planning application 18 associates descriptive characteristics with each sales forecast and/or sales order. That is, planning application 18 stores the descriptive characteristics in association with the sales forecast and/or sales order. Planning application 18 uses these descriptive characteristics to determine the importance of the sales forecast and/or sales order and customer product substitutions. The descriptive characteristics may include data defining the type of the product, the location of the product, the customer to purchase the product, and the customer's location. A list of representative additional descriptive characteristics is shown below. This list merely contains examples of descriptive characteristics that may be used and is not intended to be exhaustive. Also, it is not necessary to use all of (or even any of) the descriptive characteristics shown in the list.

Examples of descriptive characteristics that may be associated with a sales order and/or forecast include order type, reason for the order, sales organization, distribution channel, division, sales group, sales office, business area, shipping conditions, customer ordering method, cost center, customer groups, company code to be billed, sold-to party, bill-to party, payer, freight forwarder, employee making the sale, country of the sold-to party, country of the bill-to party, country of the payer, country of the freight forwarder, country of a sales representative, unloading point of the ship-to party, transportation zone of the ship-to party, different levels of customer hierarchy, price group (customers), sales district, terms of payment, payment method, product number/code, material entered, pricing reference, batch number, material group, sales document item type, product hierarchy, plant from which to ship, storage location, shipping point, route, product pricing groups, rebate information, planning plant, business transaction type for foreign trade, freight group, purchasing organization, purchasing area, purchasing group, planner, account number of regular supplier, plant category, department number, promotion category, promotion theme, season category, season year, country of regular vendor, material type, material identity, master data, prior supplier, customer number of a plant, product allocation procedures, country key region (state, province, country), country code, city code, delivery notes, net value of the order in a specified currency, document currency, complete delivery defined for the sales order, higher-level item in bill of materials structures, reason for rejection of quotations and sales orders, correlation group (indication(s) of items to be delivered together), delivery priority, an indication that delivery date and quantity are fixed, character flag(s), and name of a person who created object data relating to characteristics.

Descriptions of representative uses of some of the foregoing characteristics are provided below.

The “product code” (name) characteristic is included in the sales order and defines what the product is. For example, the product code characteristic may specify that the product is a widget. Additional characteristics may describe the product in greater detail. For example, the brand, color, size, weight, etc. (these may be specified by a user) of the product may be specified. The “product location” characteristic defines the pre-sale location of the product in the supply chain. For example, the product location characteristic may indicate a warehouse where the product is stored and from which the product can be distributed.

The “customer” characteristic specifies the identity of the customer to which the product is to be delivered. For example, the customer characteristic may specify that the product is projected to be delivered to ACME Corporation. The “customer's location” characteristic may indicate where the customer is located, e.g., Walldorf, Germany.

A customer's importance may be derived from the characteristics attached to the sales order and/or forecast. For example, the customer's name may be linked to a rule in planning application 18 that defines customer importance. In this regard, a customer's importance indicates the relative importance of a particular customer and, therefore, whether that customer is to receive some sort of preferential treatment. For example, large customers that generate large sales may be given preference when it comes to filling orders over smaller customers that generate lesser sales.

Product substitutions may be derived from certain characteristics of a sales order and/or forecast, such as the customer's name. A product substitution defines which product(s)a particular customer will allow a supplier to substitute for other products(s). Rules defined in planning application 18 may be used to determine product substitutions based on the characteristics. For example, a customer may permit a supplier to substitute one brand or type of widget for another brand or type of widget.

Thus, a forecast may be made customer-specific by associating, with the forecast, descriptive characteristics relating to a customer. A forecast may be used to determine the amount of product that a particular customer is expected to order within a specified timeframe, acceptable product substitutions, and the relative importance of the customer. Use of a customer-specific forecast provides more efficient allocation of resources for production planning.

In this embodiment, forecasts and sales orders are stored as data objects in a cache 22 on computer system 10. The descriptive characteristics are stored in a database, such as hard drive 12 on computer system 10, or elsewhere. Pointers are contained in the data objects (in cache 22) to the descriptive characteristics (in memory). Although the data objects and descriptive characteristics are shown as being stored on the same machine, they may be stored on different machines that are connected via, e.g., a network or the like.

In computer system 10, planning application 18 uses forecasts to determine which resources to allocate to produce particular products. For example, the forecasts may be used to allocate machinery to produce a certain number of products. The forecasts may also be used to allocate resources to distributing a product. For example, a certain number of delivery trucks may be allocated based on a sales order.

Planning application 18 receives sales orders from customers. The sales orders contain line items that define information, such as the product being purchased, the amount of product, the customer, etc. Sales orders that are input to planning application 18 take the place of corresponding forecasts already stored by planning application 18. What this means is that requirements from sales orders replace requirements from corresponding forecasts in cache 22. This “replacement” process is called “consuming”. Thus, a sales order “consumes” a forecast (or some portion thereof).

By way of example, a forecast may specify that 1000 widgets are to be produced. An actual sales order may enter planning application 18 for 1000 widgets. The sales order consumes the forecast in cache 22, thereby replacing the forecast with the sales order (i.e., planning application 18 replaces the forecast requirements with the sales order requirements). This is done so that planning application 18 does not allocate resources twice for the same order, i.e., based on the sales order and based on the forecast.

A sales order can consume an entire forecast or a part of a forecast. In the example described above, the sales order may be for 250 widgets. In this case, the sales order may consume only a portion of the forecast, leaving a forecast total of 750 widgets in cache 22. The resources allocated with this forecast may be used to satisfy requirements of subsequent sales orders. Alternatively, planning application 18 may replace all forecast requirements with sales order requirements, leaving no forecast in cache 22.

Using the additional descriptive characteristics described herein, it is possible to perform forecast consumption on any characteristic level. For example, including the customer in the descriptive characteristics enables the identification of customer specific forecasts for the same location/product that can be consumed by a sales order from that the same customer.

It should be noted that the customer-related descriptive characteristics described herein are only examples of descriptive characteristics that may be associated with a forecast. The processes described herein can be used with any type of descriptive characteristics, including those described herein and those not specifically described herein.

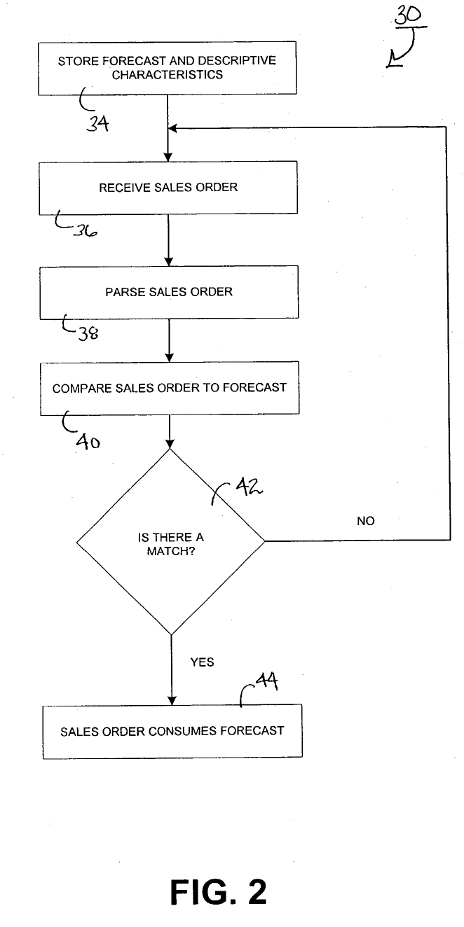

FIG. 2 shows a process 30, which is performed by planning application 18, for processing sales orders and sales forecasts. Process 30 stores (34) a sales forecast in the manner described above. Process 30 receives (36) a sales order. The sales order may be received from an external source or may be input directly into computer system 10. Process 30 parses (38) line items of the sale order to obtain information needed to satisfy the sales order. Such information may include, but is not limited to, the product being purchased, the amount of product, the customer purchasing the product, the price, etc. At least some of this information may be used to identify a forecast that corresponds to the sales order.

Process 30 compares (40) product, location, and at least one other descriptive characteristic (e.g., customer identity) from the sales forecast to the product, location, and at least one other descriptive characteristic from the sales order. If there is at least one match (42) (some embodiments may require more than one match or a complete match) between the product, location, and at least one other descriptive characteristic from the sales forecast and the product, location, and at least one other descriptive characteristic from the sales order, the sales order consumes (44) the forecast.

Whether the sales order consumes the entire sales forecast or just a portion thereof depends on the amount of product requested and system settings. If the entire forecast is consumed, it is deleted from cache 22 and replaced with the sales order. If only a portion thereof is consumed, the forecast may be modified accordingly or replaced by a new forecast. If there is no match (42) to a forecast, the sales order may be otherwise processed without regard to forecasts.

By way of example, a sales order enters planning application 18. In this example, the sales order includes several items (for possibly different location-products/characteristics) with several scheduling lines (for possibly different due dates/quantities). The forecast's descriptive characteristics are retrieved for all forecasts with the same product-location as the sales order items and for the sales order items. The forecast is then consumed.

In another example, a forecast is released from a demand planning application. The forecast includes several scheduling lines (for possibly different due dates/quantities) for the same location-product. The descriptive characteristics may be retrieved for all sales order scheduling lines of sales orders with the same product-location as the forecast and for the forecast. The forecast is then consumed.

In addition to providing the enhanced functionality described above, the descriptive characteristics associated with forecasts provide for more detailed available-to-promise (“ATP”) checks. By way of example, an ATP check is a check that is made for a sales order against a forecast to determine whether there is sufficient product available, or product that will be available, to deliver at a specified time.

By including additional descriptive characteristics with forecasts, planning application 18 can perform, e.g., customer-specific ATP checks. To this end, planning application 18 retrieves descriptive characteristics (e.g., customer identity) associated with a specific forecast to determine if there is, or will be, sufficient product to ship to, e.g., a customer. This additional level of detail provides for more specific planning than has heretofore been possible. As was the case above, the additional characteristics are not limited to customer identity. As such, planning application 18 can perform any type of characteristic-specific ATP check against forecast.

Heretofore, demand prioritization multilevel supply demand matching for forecasts was restricted to a few attributes associated with the forecast (e.g., product and location). With the additional descriptive characteristics described herein, it is possible to perform demand prioritization on any characteristic level.

In more detail, descriptive characteristics associated with forecasts may also be used to prioritize sales orders and/or forecasts. For example, as noted above, certain customers may be given a higher priority than other customers. This information may be derived from descriptive characteristics associated with a sales order or forecast. Thus, when a sales order is received, planning application 18 may identify a forecast associated with the sales order and prioritize the sales order based on the descriptive characteristics associated with the forecast. Thus, if two sales orders come in—one from a low-priority customer and one from a high-priority customer—planning application 18 can prioritize the sales orders accordingly using the descriptive characteristics. The forecasts may also be prioritized so that more resources are reserved, e.g., for high-priority customers than for low-priority customers.

It is noted that planning application 18 may also perform prioritization without reference to forecasts. That is, planning application 18 may simply obtain the relevant information, such as customer identity, from a sales order, and use the characteristics stored in hard disk 12 to prioritize the sales orders (without reference to corresponding forecasts). Alternatively, planning application 18 may perform prioritization of forecasts in the same manner described herein without reference to sales orders.

With the additional descriptive characteristics described herein, it is possible to provide product substitution rules for any characteristic, as follows.

Planning application 18 may permit product substitution using requirements of a sales order and/or forecast. As noted above, descriptive characteristics may be used to determine which product(s) a particular customer will allow a supplier to substitute for other products(s). For example, a customer may permit a supplier to substitute a first brand of widget for a second brand of widget (even though the customer ordered the second brand). When planning application 18 receives a sales order or forecast, planning application 18 may check descriptive characteristics, such as customer identity, that are pertinent to that sales order or forecast. Using the descriptive characteristics, planning application 18 can then determine if any product substitutions are permissible. Product substitution may be based on any attributes (e.g., customer, delivery date, price, etc.) associated with the sales order and/or the forecast.

The descriptive characteristics associated with the forecast may also be used in a demand planning context. For example, using the descriptive characteristics, supply objects (data objects define a supply of product) for a demand plan may be returned to a demand planning application. The supply objects that are returned are linked to a forecast and match the same characteristic values that occur in the demand planning application. Thus, for example, the demand planning application may be made aware of plant supply created for a particular customer's forecast. This information provides for more accurate and flexible demand planning.

Other Embodiments

FIG. 1 shows a computer on which the processes described herein may be implemented. Although a computer is, the processes are not limited to use with the hardware and software of FIG. 1. The processes may find applicability in any computing or processing environment. The processes may be implemented in hardware, software, or a combination thereof.

The processes described herein may be implemented using one or more computer programs executing on one or more programmable computers or other machines that each includes a processor and a storage medium that is readable by the processor (including, but not limited to, volatile and non-volatile memory and/or storage components).

Each such program may be implemented in a high-level procedural or object-oriented programming language to communicate with a computer system. However, the programs can be implemented in assembly or machine language. The language may be a compiled or an interpreted language.

Each computer program may be stored on a storage medium or other article of manufacture (e.g., CD-ROM, hard disk, or magnetic diskette) that is readable by a general or special purpose programmable computer for configuring and operating the computer when the storage medium or device is read by the computer to perform the processes described herein. The processes may also be implemented as one or more machine-readable storage media, configured with one or more computer program(s), where, upon execution, instructions in the computer program(s) cause one or more machines to operate in accordance with the processes described herein.

The processes described herein are not limited to the embodiments described. As noted, any numbers and types of descriptive characteristics may be associated with a sales forecast. The descriptive characteristics are not limited to use in the specific context described herein, but rather have more general applicability both inside of, and outside of, supply chain management software.

Other embodiments not described herein are also within the scope of the following claims.

What is claimed is:

1. A method, performed on a computer, for use in managing a supply chain, comprising:
storing a sales forecast in association with data defining a product, location, and at least one other descriptive characteristic;
receiving a sales order; and
processing the sales forecast and the sales order.

2. The method of claim 1, wherein the sales order defines a sale in terms of product, location, and at least one other descriptive characteristic; and
wherein the method further comprises:
comparing the product, location, and at least one other descriptive characteristic from the sales forecast to the product, location, and at least one other descriptive characteristic from the sales order; and
consuming at least a portion of the sales forecast if there is at least one match between the product, location, and at least one other descriptive characteristic from the sales forecast and the product, location, and at least one other descriptive characteristic from the sales order.

3. The method of claim 2, wherein consuming comprises replacing requirements of the sales forecast with requirements of the sales order.

4. The method of claim 1, wherein the at least one additional descriptive characteristic relates to customer identity.

5. The method of claim 1, wherein:
the at least one other descriptive characteristic relates to customer identity; and
the sales forecast is customer-specific.

6. The method of claim 5, wherein processing comprises:
comparing the customer identity associated with the sales order to a customer identity associated with the sales forecast; and
if the customer identity associated with the sales order corresponds to the customer identity associated with the sales forecast, the sales order consumes the sales forecast.

7. The method of claim 1, further comprising:
performing an available-to-promise check using the sales forecast based on the at least one other descriptive characteristic.

8. The method of claim 1, wherein:
the at least one other descriptive characteristic relates to customer identity; and
processing comprises prioritizing at least one of the sales order and the sales forecast by customer identity.

9. The method of claim 1, wherein:
the at least one other descriptive characteristic relates to customer identity; and
processing comprises making product substitutions for distribution based on customer identity.

10. The method of claim 1, further comprising:
performing a transfer of supply connected to a sales order or forecast to a demand planning application using the at least one other descriptive characteristic.

11. A machine-readable medium comprising executable instructions for use in managing a supply chain, the instructions causing a machine to:
store a sales forecast in association with data defining a product, location, and at least one other descriptive characteristic;
receive a sales order; and
process the sales forecast and the sales order.

12. The machine-readable medium of claim 11, wherein the sales order defines a sale in terms of product, location, and at least one other descriptive characteristic; and
wherein the machine-readable medium further comprises instructions that cause the machine to:
compare the product, location, and at least one other descriptive characteristic from the sales forecast to the product, location, and at least one other descriptive characteristic from the sales order; and
consume at least a portion of the sales forecast if there is at least one match between the product, location, and at least one other descriptive characteristic from the sales forecast and the product, location, and at least one other descriptive characteristic from the sales order.

13. The machine-readable medium of claim 12, wherein consuming comprises replacing requirements of the sales forecast with requirements of the sales order.

14. The machine-readable medium of claim 11, wherein the at least one additional descriptive characteristic relates to customer identity.

15. The machine-readable medium of claim 11, wherein:
the at least one other descriptive characteristic relates to customer identity; and
the sales forecast is customer-specific.

16. The machine-readable medium of claim 15, wherein processing comprises:
comparing the customer identity associated with the sales order to a customer identity associated with the sales forecast; and
if the customer identity associated with the sales order corresponds to the customer identity associated with the sales forecast, the sales order consumes the sales forecast.

17. The machine-readable medium of claim 11, further comprising instructions that cause the machine to:
perform an available-to-promise check using the sales forecast based on the at least one other descriptive characteristic.

18. The machine-readable medium of claim 11, wherein:
the at least one other descriptive characteristic relates to customer identity; and
processing comprises prioritizing at least one of the sales order and the sales forecast by customer identity.

19. The machine-readable medium of claim 11, wherein:
the at least one other descriptive characteristic relates to customer identity; and
processing comprises making product substitutions for distribution based on customer identity.

20. The machine-readable medium of claim 11, further comprising instructions that cause the machine to:
performing a transfer of supply connected to a sales order or forecast to a demand planning application using the at least one other descriptive characteristic.

21. An apparatus for use in managing a supply chain, comprising:
a memory that stores executable instructions; and
a processor that executes the instructions to:
store a sales forecast in association with data defining a product, location, and at least one other descriptive characteristic;
receive a sales order; and
process the sales forecast and the sales order.

22. The apparatus of claim 21, wherein the sales order defines a sale in terms of product, location, and at least one other descriptive characteristic; and
wherein the processor executes instructions to:
compare the product, location, and at least one other descriptive characteristic from the sales forecast to the product, location, and at least one other descriptive characteristic from the sales order; and
consume at least a portion of the sales forecast if there is at least one match between the product, location, and at least one other descriptive characteristic from the sales forecast and the product, location, and at least one other descriptive characteristic from the sales order.

23. The apparatus of claim 22, wherein consuming comprises replacing requirements of the sales forecast with requirements of the sales order.

24. The apparatus of claim 21, wherein the at least one additional descriptive characteristic relates to customer identity.

25. The apparatus of claim 21, wherein:
the at least one other descriptive characteristic relates to customer identity; and
the sales forecast is customer-specific.

26. The apparatus of claim 25, wherein processing comprises:
comparing the customer identity associated with the sales order to a customer identity associated with the sales forecast; and
if the customer identity associated with the sales order corresponds to the customer identity associated with the sales forecast, the sales order consumes the sales forecast.

27. The apparatus of claim 21, wherein the processor executes instructions to:
perform an available-to-promise check using the sales forecast based on the at least one other descriptive characteristic.

28. The apparatus of claim 21, wherein:
the at least one other descriptive characteristic relates to customer identity; and
processing comprises prioritizing at least one of the sales order and the sales forecast by customer identity.

29. The apparatus of claim 21, wherein:
the at least one other descriptive characteristic relates to customer identity; and
processing comprises making product substitutions for distribution based on customer identity.

30. The apparatus of claim 21, wherein the processor executes instructions to:
perform a transfer of supply connected to a sales order or forecast to a demand planning application using the at least one other descriptive characteristic.

31. The method of claim 1, further comprising obtaining a sales forecast that is specific to the at least one other descriptive characteristic.

32. The machine-readable medium of claim 11, further comprising instructions to obtain a sales forecast that is specific to the at least one other descriptive characteristic.

33. The apparatus of claim 21, wherein the processor executes instructions to obtain a sales forecast that is specific to the at least one other descriptive characteristic.
